(19) United States
(12) Patent Application Publication
(10) Pub. No.: US 2009/0148586 A1
(43) Pub. Date: Jun. 11, 2009

(54) CITRUS JUICE SACS WITH AROMA ADDITION

(75) Inventors: Sven Siegel, Holzminden (DE); Gerhard Krammer, Holzminden (DE); Heinz-Jurgen Bertram, Holzminden (DE); Angela Barnard, Holzminden (DE)

Correspondence Address: CONNOLLY BOVE LODGE & HUTZ LLP, 1875 EYE STREET, N.W., SUITE 1100, WASHINGTON, DC, 20006, US

(73) Assignee: SYMRISE GmbH & Co. KG, Holzminden (DE)

(21) Appl. No.: 12/326,438

(22) Filed: Dec. 2, 2008

Related U.S. Application Data
(60) Provisional application No. 61/012,107, filed on Dec. 7, 2007.

(51) Int. Cl. A23L 1/222

(52) U.S. Cl. 426/616

(57) ABSTRACT

Described is a mixture comprising or consisting of intact, separated citrus juice sacs with aroma addition, wherein these citrus juice sacs have based on their total weight an aroma content of 50 ppm (0.005% by weight) or more.

The present invention relates to mixtures comprising or consisting of intact, separated citrus juice sacs with aroma addition, i.e. with an addition of one or more aromas which are not present or are present only in a relatively low amount in natural citrus juice sacs. With regard to further features of a mixture according to the invention, see below.

The present invention relates in further aspects to the use of a mixture according to the invention as (a) a means for aromatizing preparations or semifinished products used for nutrition, or consumption for pleasure or (b) a corresponding semifinished product or (c) a preparation used for nutrition, or consumption for pleasure.

A further aspect of the present invention relates to methods for producing a mixture according to the invention.

Finally, the present invention also relates to the use of an aroma preparation as a means for increasing the aroma content of the encased juice of a citrus juice sac.

The production of intact, separated citrus juice sacs is the subject-matter of U.S. Pat. No. 3,246,993 and GB 978 418. In this case, the fruits are peeled and immersed into a cold liquid having a temperature of less than 100° F. (−73° C.). This cold shock treatment and the subsequent rapid heating cause the fruit to shatter. The juice sacs remain intact and can be easily separated from the remaining constituents by sieving or other separating methods. The separation of the juice sacs can be assisted by stirring or moving the fruits, provided that they are frozen. The separated juice sacs can be further processed to form a juice. The separation of the juice sacs from the remaining fruit constituents increases the quality of the juice. The separated sacs can furthermore be stored frozen. Examples of cold liquids include liquid nitrogen, liquefied nitrogen oxides, carbon dioxide, argon, helium and liquid air.

JP 62000262 describes an apparatus for separating the juice sacs of citrus fruits. The fruit is frozen in a liquid medium, disintegrated by impact or striking and the separated juice sacs are selected.

U.S. Pat. No. 4,294,861 discloses a method and an apparatus for obtaining separated juice sacs. The citrus fruits can be processed without complex pretreatment. After halving of the fruits, a jet of liquid is directed against the cut surfaces. The pulp is flushed out and is broken down into the individual juice sacs.

A further method for producing separated juice sacs is disclosed in U.S. Pat. No. 4,560,572. After a pretreatment which includes peeling and separating into segments, the fruits are optionally supplied to extra-gastric digestion. The segments or clusters are transferred in a specially designed apparatus into separated, undamaged juice sacs.

JP 57150373 describes an apparatus for separating juice sacs from citrus fruit segments using a cylindrical separating net. The segments are transported into the cylindrical separating net and treated there with a water jet. In this case, the segments are separated into the individual juice sacs. The juice sacs pass through the net and are collected in a water tank.

U.S. Pat. No. 4,738,194 describes an apparatus for separating the juice sacs of citrus fruits. The apparatus comprises a freezing unit in which the citrus fruits are frozen with a cryogenic liquid. In a breaker the frozen fruits are crushed and in a separator the separated juice sacs are separated from the remaining constituents of the citrus fruits.

JP 58158153 describes a method for sorting citrus juice sacs and an apparatus therefor. In the described process, large amounts of unsorted juice sacs of citrus fruits are sorted by removing seeds and unripe sacs. As a product, corresponding juice sacs are obtained for producing fruit juice.

However, the prior art does not describe the production of intact, separated citrus juice sacs having a high aroma content and long shelf life. The aroma content of separated citrus juice sacs is of course conventionally not more than 15 ppm based on the total weight of the citrus juice sac. Accordingly, with the citrus juice sacs known in the art, it is possible to aromatize food products only by using very large amounts. In addition, there is the problem that within preservation of the citrus juice sacs conventionally further high aroma losses and/or aroma changes occur. For example, segments sterilized in this way of mandarin oranges in tins are less aromatic and the individual juice sacs are of soft consistency. It has been found that the aroma can be spared and the texture can be spared merely by freezing the juice sacs, the freezing taking place rapidly at very low temperatures of less than −73° C., preferably at temperatures of approx. −200° C. Carrying out this rapid freezing requires cryogenic gases such as nitrogen, which cause a number of further problems. The production of the cryogenic gases is energy-intensive and the handling and storage thereof require specific safety measures to be adhered to. Finally, the cold-liquefied gases can usually not be recovered so that, viewed globally, the use thereof is expensive. On the other hand, the freezing at relatively moderate temperatures of above −73° C. damages the citrus juice sacs so intensively that after thawing, the juice contained seeps out. The low freezing rate leads to the formation of very large ice crystals which cause mechanical destruction of the citrus juice sacs. The aim of producing intact, separated citrus juice sacs is thus unsuccessful.

The object of the present invention was to disclose mixtures comprising or consisting of intact, separated citrus juice sacs having an increased aroma content compared to natural citrus juice sacs. Furthermore, the mixtures to be disclosed should comprise or consist of intact, separated citrus juice sacs, the citrus juice sacs having preferably high freeze stability and thaw stability. This then results in overall increased stability in storage.

Furthermore, the present invention is intended to provide methods for producing the mixture to be disclosed, i.e. in particular methods with which the aroma content of intact, separated citrus juice sacs is increased.

Further statements of object on which the present invention is based will emerge from the following discussion and the appended claims.

According to the invention, the aspect of the statement of object relating to the mixtures to be disclosed is achieved by a mixture comprising or consisting of intact, separated citrus juice sacs with aroma addition, wherein these citrus juice sacs have based on their total weight
an aroma content of 50 ppm (0.005% by weight) or more.

Insofar as the mixture according to the invention consists of said intact, separated citrus juice sacs with aroma addition, it is an accumulation of citrus juice sacs of this type.

Preferred are mixtures according to the invention comprising or consisting of intact, separated citrus juice sacs with aroma addition, wherein these citrus juice sacs have based on their total weight even
an aroma content of 500 ppm (0.05% by weight) or more, preferably 1,000 ppm (0.1% by weight) or more.

Preferably, the proportion formed by the aroma addition of the aroma total weight of said citrus juice sacs is 50% by weight or more. If the total weight of the aromas contained in the citrus juice sacs according to the invention is thus determined, then the proportion of the aromas naturally present in the citrus juice sacs is preferably 50% by weight or less.

Accordingly, a further aspect of the present invention relates to mixtures according to the invention, wherein the proportion formed by the aroma addition of the aroma total weight of said citrus juice sacs is 50% by weight or more.

Owing to the aroma addition, i.e. owing to the increased aroma content of the citrus juice sacs used in accordance with the invention, the mixtures according to the invention are particularly suitable for aromatizing preparations, such as for example food products or other preparations used for consumption for pleasure, or nutrition.

Surprisingly, the citrus juice sacs which are present in the mixtures according to the invention and have aroma addition are particularly readily preservable. The intact, separated citrus juice sacs with aroma addition can be preserved particularly successfully by freezing, and independent tests have revealed that mixtures according to the invention have surprisingly high freeze and thaw stability, so that they are especially stable in storage in particular when frozen. It is therefore particularly preferable if, in a mixture according to the invention, the citrus juice sacs contained therein with aroma addition are frozen.

A method according to the invention for producing a mixture according to the invention includes the following steps:
a) preparing intact, separated citrus juice sacs, and
b) contacting the citrus juice sacs with one or more liquid aroma preparations, so that the aroma content of the citrus juice sacs is increased.

Preferably, a method according to the invention includes the following further step:
c) freezing the citrus juice sacs obtained in accordance with step b) with aroma addition, in the presence or absence of the liquid aroma preparation or preparations.

Mixtures comprising frozen, intact, separated citrus juice sacs with aroma addition are preferably obtained in that the corresponding citrus juice sacs are frozen (conventionally in step c) of a method according to the invention) at a temperature in the range between their freezing temperature and a temperature above −73° C., preferably at a temperature in the range of from −15 to −40° C.

Therefore, a further aspect of the present invention discloses a method as defined above, further characterized in that the freezing of the citrus juice sacs in step c) takes place at a temperature in the range between their freezing temperature and a temperature above −73° C., preferably at a temperature in the range of from −15 to −40° C.

Freezing temperatures which are higher than the previously conventional temperatures are thus suitable for preserving mixtures according to the invention (in particular mixtures of the type consisting of citrus juice sacs to be used in accordance with the invention) (cf. the above-assessed documents U.S. Pat. No. 5,246,993 and GB 978418). A corresponding configuration of the method according to the invention is therefore particularly economical and environmentally-friendly, while at the same time leading to intact, separated citrus juice sacs which are stable in storage and have a high aroma content.

The intact, separated citrus juice sacs with aroma addition, which are used or produced within the scope of the present invention, have conventionally
a dry substance content of from 3-30% by weight, and
a water content of from 69.995-96.995% by weight.

The term “citrus juice sacs” refers in the context of the present text to juice-containing sacs (also known as sacks, cells, vesicles) such as naturally occur in citrus fruits. The term “citrus juice sacs with aroma addition” denotes corresponding juice sacs, the aroma content of which is increased by a corresponding treatment method. Citrus juice sacs (in the untreated state) are endocarp emergents which issue from the endocarp in the form of small, juice-filled sacks inwardly into the individual fruit segments of the citrus fruit and fill said segments. The juice inside a citrus juice sac is in this case encased by an epidermis. Citrus juice sacs are usually tubular to claviform, can easily be identified by eye and generally fill up most of the space of the citrus fruit. A large number of juice sacs are combined to form what are known as segments (also clusters, ovarian locules), each segment being encased by a membrane (skin). Approximately 5 to 15 segments are arranged radially in each citrus fruit. The segments are encased by the whitish mesocarp (albedo) and the arrangement as a whole is finally protected outwardly by the exocarp (flavedo). The citrus juices, for example orange juice, contained in citrus juice sacs can be obtained therefrom.

The term “citrus fruits” denotes the fruits of plants of the genus Citrus L. from the family of the Rutaceae. Furthermore, the term “citrus fruits” also refers to fruits of plants of the genus Fortunella, Poncirus, Microcitrus, Eremocitrus and crossings (hybrids) from plants of the aforementioned genera. Important species of the described genera and crossings include for example: Citrus sinensis, Citrus reticulata, Citrus limon, Citrus grandis, Citrus medica, Citrus aurantifolia, Citrus aurantium, Citrus mitis, Citrus maxima, Citrus medica, Citrus glauca (also known as Eremocitrus glauca), Citrus australasica (also known as Microcitrus australasica), Citrus sphaerocarpa, Citrus x paradisi, Citrus x aurantium, Citrus x limonia, Citrus x latifolia, Poncirus trifoliata, Citrus x macrophylla, Citrus x bergamia, Citrus x amblycarpa, Citrus x pennivesiculata, Citrus x ichangensis, Citrus limon x, Citrus paradisi, Citrus x hystrix, Citrus x latipes, Citrus x limon, Citrus x limetta, Citrus x Fortunella Hybrids, Citrus x limonia, Citrus x natsudaidai, Citrus x jambhiri, Citrus x depressa, Citrus x sunki, Citrus x limettioides, Citrus x nobilis and Citrus x junos.

Citrus fruits which are particularly suitable for use within the scope of the present invention include for example orange, mandarin, tangerine, lemon, grapefruit, shaddock, citrus lemon, lime, sour orange, bitter orange, calamondin, kumquat, bergamot, tangelo. Examples of further suitable citrus fruits include: alemow, amanatsu, blood orange, bergamot orange, calamondin, clementine, finger lime, gajanimma, carabao lime, ichang lemon, imperial lemon, iyokan, kabosu, kaffir lime, key lime, kinnow, khasi pepeda, cedrate, limequat, mandarin orange, mandarin lime, meyer lemon, mikan, natsumikan, orangelo, orangequat, oroblanco, Persian lime, pomelo, ponderosa lemon, ponkan, rangpur, lemanderin, rough lemon, satsuma, shekwasha, sudachi, sunkie, sweetie, sweet lime, tachibana orange, tangor, ugli fruit and yuzu.

Specific types of orange which are particularly suitable for use within the scope of the present invention include for example: blonde oranges (for example baladi, shamouti, jaffa orange, Hamlin, Hart's tadiff Valencia, Valencia late), navel oranges (also known as: bahia oranges) (for example cara cara, navelate, navelina, Washington navel), blood oranges (for example double fine, manica, moro, sanguine, sanguinello, tarocco) and acid-free oranges (for example mosambi).

For the purposes of the present invention, preferred suitable citrus fruits include: oranges, blood oranges, lemons, shaddocks, mandarins, grapefruits, pomelos, mandarin oranges, clementines, satsumas and tangerines.

The term “aroma” denotes in the present text individual substances (aroma substances) or a mixture of individual substances (aroma substances) and if appropriate aroma solvents. The aroma content of the intact, separated citrus juice sacs to be used in accordance with the invention with aroma addition is composed of a content of naturally present aroma and a content of added aroma (in the aroma addition).

Comments were made hereinbefore on preferred aroma contents and the preferred proportion formed by the aroma addition of the aroma total weight of the citrus juice sacs to be used in accordance with the invention. This discussion itself reveals that mixtures according to the invention are clearly distinguished, through their particularly high aroma content, from the previously known mixtures comprising or consisting of intact, separated citrus juice sacs. A mixture according to the invention can comprise, in addition to the intact, separated citrus juice sacs to be used in accordance with the invention with aroma addition, also a number of non-intact and/or non-separated citrus juice sacs. The numerical proportion of the separated, intact or non-intact citrus juice sacs, i.e. the proportion of separated citrus juice sacs (irrespective of whether or not they are intact) is preferably 50% or more, based on the total amount of the citrus juice sacs, but preferably 90% or more, preferably 95% or more and most particularly preferably 99% or more. The numerical proportion of the intact, separated or non-separated citrus juice sacs, i.e. the proportion of the intact citrus juice sacs (irrespective of whether or not they are separated) is preferably 50%, based on the total amount of the citrus juice sacs, but particularly preferably 65% or more and most particularly preferably 85% or more. Preferably, both statements concerning the numerical proportions of the separated or the intact citrus juice sacs apply simultaneously for a mixture according to the invention, although this does not have to be the case.

Preferably, a mixture according to the invention is a preparation used for (a) nutrition, or (b) consumption for pleasure or (c) a corresponding semifinished product. Most particularly preferably, mixtures according to the invention are frozen food product preparations or corresponding semifinished products. Also preferred are mixtures according to the invention which are a preparation comprising, in addition to frozen constituents, in particular frozen food product components comprising intact, separated citrus juice sacs to be used in accordance with the invention with aroma addition.

The present invention also relates to a corresponding use of a mixture according to the invention as (a) a means for aromatizing preparations or semifinished products used for nutrition, or consumption for pleasure or (b) a corresponding semifinished product or (c) a preparation used for nutrition, or consumption for pleasure.

The invention relates in particular to mixtures comprising intact, separated citrus juice sacs with aroma addition (as described hereinbefore, in particular in one of the configurations said to be preferred), wherein the mixture according to the invention comprises, in addition to said citrus juice sacs, also one or more constituents from the group consisting of: milk, a dairy product (for example yoghurt, yoghurt drinks, cream cheese preparations, quark, probiotic yoghurt, probiotic yoghurt drink, curdled milk, kefir, dairy ice cream, buttermilk), fruit preparation (for example fruit jelly, marmalade, jam, fruit fillings, fruit ice cream, sorbet), dessert preparation (for example pudding, ambrosia), fatty mass (for example bakery product filling for, for example, cookie filling, chocolate fatty filling, bar fatty filling), alcoholic or non-alcoholic beverage (for example coffee, tea, wine, wine-containing beverage, beer, beer-containing beverage, liqueur, schnapps, brandy, fruit-containing lemonade, isotonic beverage, soft drink, nectar, fruit and vegetable juice, fruit or vegetable juice preparation), meat product (for example spiced or marinated fresh or cured meat product), product made of soy protein or other soy bean fractions (for example soy milk or a product produced therefrom), vegetable preparation (for example ketchup, sauces, deep-frozen vegetables, precooked vegetables, vegetables pickled in vinegar, vegetable preserves), fat and oil-based product or corresponding emulsion (for example mayonnaise, remoulade, dressing, seasoning preparation).

The intact, separated citrus juice sacs to be used in accordance with the invention with aroma addition can be part of: ready meals and soups (for example precooked soups), deep-frozen food (deep-frozen ready meals such as rice, noodle, meat, fish, poultry and potato meals, deep-frozen tarts and cakes) and bakery products (for example cakes, tarts). Each of the aforementioned foods is (owing to the presence of the intact, separated citrus juice sacs to be used in accordance with the invention with aroma addition) a mixture according to the invention.

It will be understood that the intact, separated citrus juice sacs to be used in accordance with the invention with aroma addition can be incorporated into the corresponding food product or applied to the surface thereof (for example on the upper side, underside or lateral surface).

It has already been mentioned that, in a production method according to the invention, the freezing of the citrus juice sacs in step c) takes place preferably at a temperature in the range between their freezing temperature and a temperature above −73° C. Preferred in this case is a temperature in the range of from −15 to −40° C. The term “the freezing temperature of the citrus juice sacs” refers in this case to the temperature at which the juice contained in the citrus juice sacs freezes. This is often the case at temperatures of just below 0° C.

In a production method according to the invention, step b) is preferably carried out in such a way that one, a plurality of or all the aroma substances are taken up from the liquid aroma preparation or preparations into the citrus juice sacs, preferably into the encased juice of the citrus juice sacs. In practice, this means that the intact, separated citrus juice sacs, the aroma content of which is to be increased, are contacted with the liquid aroma preparation or preparations at such a temperature until the aroma content of the citrus juice sacs (preferably the aroma content of the encased juice of the citrus juice sacs) has significantly increased. A person skilled in the art can determine based on simple preliminary tests what treatment times and what treatment temperatures are suitable for a given aromatizing task. He can also determine based on simple preliminary tests how a liquid aroma preparation should be composed in order to achieve optimally prompt infiltration of aroma into the citrus juice sacs in question. As mentioned hereinbefore, in the production method according to the invention, the aroma preparations are present in liquid form. It is thus possible to use aroma substances which are per se liquid and also aroma substances which, owing to the presence of a solvent, are present in dissolved form. Preferably, the freezing point of a liquid aroma preparation for use in a production method according to the invention is below 0° C., preferably below −18° C., particularly preferably below −30° C. Whereas in a production method according to the invention, in a step c), the citrus juice sacs obtained in step b) with aroma addition are to be frozen, wherein the liquid aroma preparations are intended to be present during the freezing process, the liquid aroma preparation used preferably has a freezing point which is below the temperature selected in step c) of the corresponding method for freezing. A person skilled in the art will set the freezing point of the liquid aroma preparation to be used as he desires by way of the purposeful use of additives and by way of a purposeful selection of solvents and the like.

A large number of aroma preparations and aromas (aroma substances and the mixtures thereof) are suitable for increasing the aroma content of intact, separated citrus juice sacs. Particularly suitable are:

extracts from natural raw materials such as essential oils, concretes, absolutes, resins, resinoids, balsams, tinctures; amyris oil; angelica seed oil; angelica root oil; anise oil; valerian oil; basil oil; wood moss absolute; bay oil; mugwort oil; benzoin resin; bergamot oil; beeswax absolute; birch tar oil; bitter almond oil; savory oil; bucco leaf oil; cabreuva oil; cade oil; calmus oil; camphor oil; cananga oil; cardamom oil; cascarilla oil; cassia oil; cassia absolute; castoreum absolute; cedar leaf oil; cedarwood oil; cistus oil; citronella oil; lemon oil; copaiva balsam; copaiva balsam oil; coriander oil; costus root oil; cumin oil; cypress oil; davana oil; dill herb oil; dill seed oil; oakmoss absolute; elemi oil; estragon oil; eucalyptus citriodora oil; eucalyptus oil; fennel oil; spruce needle oil; galbanum oil; galbanum resin; geranium oil; grapefruit oil; guaiac wood oil; gurjun balsam; gurjun balsam oil; helichrysum absolute; helichrysum oil; ginger oil; iris root absolute; iris root oil; jasmine absolute; calamus oil; camomile blue oil; camomile Roman oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemongrass oil; lavage oil; distilled lime oil; pressed lime oil; linaloe oil; litsea cubeba oil; bayleaf oil; mace oil; marjoram oil; mandarin oil; massoi bark oil; mimosa absolute; musk seed oil; musk tincture; clary sage oil; nutmeg oil; myrrh absolute; myrrh oil; myrtenol; clove leaf oil; clove flower oil; neroli oil; olibanum absolute; olibanum oil; opopanax oil; orange-flower absolute; orange oil; origanum oil; palmarosa oil; patchouli oil; perilla oil; peruvian balsam oil; parsley leaf oil; parsley seed oil; petitgrain oil; peppermint oil; pepper oil; pimenta oil; pine oil; pennyroyal oil; rose absolute; rosewood oil; rose oil; rosemary oil; dalmation sage oil; Spanish sage oil; celery seed oil; spike lavender oil; Japanese anise oil; styrax oil; tagetes oil; fir needle oil; teatree oil; turpentine oil; thyme oil; tolu balsam; tonka absolute; tuberose absolute; vanilla extract; violet leaf absolute; verbena oil; vetiver oil; juniper oil; wine lees oil; absinthe oil; wintergreen oil; ylang oil; hyssop oil; civet absolute; cinnamon leaf oil; cinnamon bark oil; and fractions thereof, or ingredients isolated therefrom.

Individual substances (aroma substances) which are particularly suitable for increasing the aroma content are compounds from the group of the hydrocarbons, such as for example 3-carene; α-pinene; β-pinene; α-terpinene; γ-terpinene; p-cymene; bisabolene; camphene; caryophyllene; cedrene; farnesene; limonene; longifolene; myrcene; ocimene; valencene; (E,Z)-1,3,5-undecatriene;

the aliphatic alcohols such as for example hexanol; octanol; 3-octanol; 2,6-dimethylheptanol; 2-methylheptanol, 2-methyloctanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol; the aliphatic aldehydes and the 1,4-dioxacycloalken-2-ones thereof such as for example hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-5,9-undecadienal; heptanaldiethylacetal; 1,1-dimethoxy-2,2,5-trimethyl-4-hexene;
the aliphatic ketones and the oximes thereof such as for example 2-heptanone; 2-octanone; 3-octanone; 2-nonanone; 5-methyl-3-heptanone; 5-methyl-3-heptanone oxime; 2,4,4,7-tetramethyl-6-octen-3-one; the aliphatic sulfur-containing compounds such as for example 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;
the aliphatic nitriles such as for example 2-nonenenitrile; 2-tridecenenitrile; 2,12-tridecadienenitrile; 3,7-dimethyl-2,6-octadienenitrile; 3,7-dimethyl-6-octenenitrile;
the aliphatic carboxylic acids and the esters thereof such as for example (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate, isoamyl butyrate; hexyl butyrate; (E)- and (Z)-3-hexenyl isobutyrate; hexyl crotonate; ethyl isovalerate; ethyl-2-methylpentanoate; ethyl hexanoate; allyl hexanoate; ethyl heptanoate; allyl heptanoate; ethyl octanoate; ethyl(E,Z)-2,4-decadienoate; methyl-2-octynoate; methyl-2-nonynoate; allyl 2-isoamyl oxyacetate; methyl-3,7-dimethyl-2,6-octadienoate;
the acyclic terpene alcohols such as for example citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the formates, acetates, propionates, isobutyrates, butyrates, isovalerates, pentanoates, hexanoates, crotonates, tiglinates, 3-methyl-2-butenoates thereof;
the acyclic terpene aldehydes and ketones such as for example geranial; neral; cirtonellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal;
the cyclic terpene alcohols such as for example menthol; isopulegol; alpha-terpineol; terpineol-4; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates, 3-methyl-2-butenoates thereof;
the cyclic terpene aldehydes and ketones such as for example menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-iron; alpha-damascone; beta-damascone; beta-damascenone; delta-damascone; gamma-damascone; 1-(2,4,4-trimethyl-2-cyclo-hexen-1-yl)-2-buten-1-one; 1,3,4,6,7,8a-hexahydro-1,1,5,5-tetramethyl-2H-2,4a-methanonaphthalen-8(5H)-one; nootkatone; dihydronootkatone; alpha-sinensal; beta-sinensal;
the cyclic alcohols such as for example 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;
the cycloaliphatic alcohols such as for example alpha-3,3-trimethylcyclohexylmethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)-hexan-3-ol;
the esters of cycloaliphatic carboxylic acids such as for example allyl-3-cyclohexylpropionate; allyl cyclohexyloxyacetate; methyl dihydrojasmonate; methyl jasmonate; methyl-2-hexyl-3-oxocyclopentanecarboxylate; ethyl-2-ethyl-6,6-dimethyl-2-cyclohexenecarboxylate; ethyl-2,3,6,6-tetramethyl-2-cyclohexenecarboxylate; ethyl-2-methyl-1,3-dioxolan-2-acetate;
the aromatic hydrocarbons such as for example styrene and diphenylmethane;
the araliphatic alcohols such as for example benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;
the esters of araliphatic alcohols and aliphatic carboxylic acids such as for example benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate; the araliphatic ethers such as for example 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaldehyde dimethyl acetal; phenylacetaldehyde glycerol acetal;
the aromatic and araliphatic aldehydes such as for example benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 3-(4-tert-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;
the aromatic and araliphatic ketones such as for example acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; benzophenone;
the aromatic and araliphatic carboxylic acids and the esters thereof such as for example benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl-2,4-dihydroxy-3,6-dimethylbenzoate; ethyl-3-phenyl glycidate; ethyl-3-methyl-3-phenyl glycidate;
the nitrogen-containing aromatic compounds such as for example 2,4,6-trinitro-1,3-dimethyl-5-tert-butylbenzene; 3,5-dinitro-2,6-dimethyl-4-tert-butylacetophenone; cinnamonitrile; 5-phenyl-3-methyl-2-pentenenitrile; 5-phenyl-3-methylpentanenitrile; methyl anthranilate; methyl N-methylanthranilate; Schiff bases of methyl anthranilate with 7-hydroxy-3,7-dimethyloctanal; 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; indole; skatole; 2-methoxy-3-isopropylpyrazine; 2-isobutyl-3-methoxypyrazine;
the phenols, phenyl ethers and phenyl esters such as for example estragole; anethole; eugenole; eugenyl methyl ether; isoeugenole; isoeugenyl methyl ether; thymole; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;
the heterocyclic compounds such as for example 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
the lactones such as for example 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 1,15-pentadecanolide; cis and trans-11-pentadecen-1,15-olide; cis and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

Aroma substances preferably to be used within the scope of the present invention are selected from the group consisting of:

acetaldehyde, acetylmethylcarbinol, acetophenone, allyl caproate, alpha-ionone, beta-ionone, anisaldehyde, anisyl acetate, anisyl formate, benzaldehyde, benzothiazole, benzyl acetate, benzyl acetate, benzyl alcohol, benzyl benzoate, beta-ionone, butyl butyrate, butyric acid, butyl caproate, butylidene phthalide, capric acid, caproic acid, caprylic acid, carvone, camphene caryophyllene, cineol, cinnamyl acetate, citral, citronellol, citronellal, citronellyl acetate, cyclohexyl acetate, cymol, damascone, decalactone, diacetyl, dihydrocoumarin, dimethyl anthranilate, dimethyl anthranilate, dodecalactone, acetic acid, ethoxyethyl acetate, ethyl acetate, ethylbutyric acid, ethyl butyrate, ethyl caprinate, ethyl caproate, ethyl crotonate, ethyl formate, ethyl furaneol, ethyl guajacol, ethyl isobutyrate, ethyl isovalerate, ethyl lactate, ethyl lactate, ethyl maltol, ethyl methyl butyrate, ethyl propionate, eucalyptol, eugenol, ethyl heptylate, Frambinone®, gamma-decalactone, geraniol, geranyl acetate, geranyl acetate, grapefruit aldehyde, hedione, heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxy benzyl acetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, maltol, menthol, menthofuran, methyl anthranilate, methylbutanol, methylbutyric acid, 2-methylbutyl acetate, methyl caproate, methyl cinnamate, 5-methyl furfural, 3,2,2-methyl cyclopentenolone, 6,5,2-methyl heptenone, methyl dihydrojasmonate, methyl jasmonate, 2-methyl methyl butyrate, 2-methyl-2-pentenoic acid, methylthiobutyrate, 3,1-methylthiohexanol, 3-methylthiohexyl acetate, nerol, neryl acetate, trans,trans,2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propionic acid, propyl butyrate, pulegone, pulegol, sinensal, sulfurol, terpinene, terpineol, terpinolene, 8,3-thiomenthanone, 4,4,2-thiomethyl pentanone, thymol, delta-undecalactone, gamma-undecalactone, valencene, valeric acid, vanillin, acetoin, ethyl vanillin, ethyl vanillin isobutyrate (=3-ethoxy-4-isobutyryloxybenzaldehyde), Furaneol® (2,5-dimethyl-4-hydroxy-3(2H)-furanone) and the derivatives thereof (in this case preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (in this case preferably ethyl maltol), coumarin and coumarin derivatives, gamma-lactones (in this case preferably gamma-undecalactone, gamma-nonalactone, gamma-decalactone), delta-lactones (in this case preferably 4-methyl delta decalactone, massoia lactone, delta decalactone, tuberose lactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methylbutyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenyl glycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulfide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, mercapto-3-methyl-1-butanol, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 2,3-butanedione, 4-hydroxy-2,5-dimethyl-3(2H)-furanone, guajacol, 3-hydroxy-4,5-dimethyl-2(5H)-furanone, 3-hydroxy-4-methyl-5-ethyl-2(5H)-furanone, dimethyl sulfide, trimethylamine, cinnamaldehyde, cinnamyl alcohol, methyl salicylate, isopulegol and further stereoisomers, enantiomers, positional isomers, diastereomers, cis/trans-isomers or epimers not mentioned in the present document of these substances.

Aroma preparations which are particularly preferably to be used within the scope of the present invention comprise or consist of a citrus aroma substance (or an aroma substance having similar aroma properties), the use of which in a method according to the invention or a use according to the invention leads to an increase in the citrus aroma content of said intact, separated citrus juice sacs over the citrus aroma content naturally present in the citrus juice sacs. This can provide or strengthen a particularly intensive, natural aroma impression.

Preferred mixtures according to the invention accordingly comprise a citrus aroma content of 50 ppm (0.005% by weight) or more, preferably of 500 ppm (0.05% by weight) or more, preferably 1,000 ppm (0.1% by weight) or more.

The proportion formed by added citrus aroma of the aroma total weight of said citrus juice sacs is in preferred mixtures according to the invention 50% by weight or more.

Liquid aroma preparations to be used in accordance with the invention can comprise, as stated hereinbefore, aroma solvents. Use is preferably made within the scope of the present invention of solvents, suitable for human consumption, for aroma substances. Preferred aroma solvents are therefore ethanol, fatty oils, for example edible oils and in particular vegetable oils such as for example borage oil, thistle oil, peanut oil, hazelnut oil, coconut oil, pumpkin seed oil, linseed oil, maize germ oil, macadamia nut oil, almond oil, olive oil, pecan nut oil, pistachio kernel oil, rape oil, rice germ oil, sesame oil, soy oil, sunflower oil, walnut oil or wheat germ oil, fractionated coconut oils having mainly fatty acid radicals having a length of six to eight carbon atoms (C6-C8 fatty acids), propylene glycol, diacetin (glycerol diacetate), triacetin (glycerol triacetate), benzyl alcohol, triethyl citrate, ethyl lactate, isopropanol and glycerol.

The term “intact, separated citrus juice sacs” denotes citrus juice sacs which are both intact (as defined hereinafter) and separated (as defined hereinafter).

The term “separated citrus juice sacs” denotes citrus juice sacs which have been separated out from corresponding citrus fruit segments and can be moved independently of those citrus juice sacs which adjoined them in the original citrus fruit segment. Separated citrus juice sacs are, especially when they have been separated using conventional separating methods, often free from other constituents of the citrus fruit.

As citrus juice sacs are conventionally separated using technical methods, it is possible that a certain proportion of citrus juice sacs will not be completely separated even after the method has been carried out, but rather be in the form of accumulated piles having a sac number of from 2 to 40, preferably 2 to 20 and particularly preferably 2 to 5. Accordingly, a mixture according to the invention can comprise, in addition to separated (preferably intact) citrus juice sacs, also piles of this type of citrus juice sacs. However, the proportion of separated citrus juice sacs in a mixture of this type should be, as stated hereinbefore in a different context, at least based on the total amount of the citrus juice sacs 50% or more, preferably 90% or more, preferably 95% or more and particularly preferably 99% or more.

The term “intact citrus juice sacs” denotes citrus juice sacs having an intact sac delimitation (sac casing; epidermis). A sac delimitation (sac casing) is intact when it surrounds the sac content (juice) completely and without gaps and thus prevents leakage. Intact citrus juice sacs contain in the outer sac casing no relevant defects, such as can be caused for example by mechanical effects (especially tearing, cutting, crushing) or by freezing and thawing. An intact sac casing prevents osmosis. If a citrus juice sac having an intact casing is immersed into an (external) liquid, the juice present in the interior of the citrus juice sac and the external liquid remain completely separate from each other. During immersion of an intact citrus juice sac into a solution having a low proportion of dissolved constituents (for example distilled water), the water diffuses through the sac casing (semipermeable membrane) into the interior of the sac, ultimately increasing the volume of the sac. The resulting citrus juice sac then appears larger and more solid. In aqueous solutions having a high concentration of dissolved substances (for example sugar sirup or saturated saline solutions), water diffuses out of the intact citrus juice sac into the solution; this results in a side-reduced sac volume and the sac becomes flaccid.

Sure signs of the presence of a non-intact citrus juice sac are breaking points, cutting points or cracks which are discernible even with the naked eye or under a microscope at low magnification (magnification approx. 2 to 100 times). In some cases, citrus juice sacs display even relatively large air bubbles which indicate a non-intact citrus juice sac. In many cases, concealed defects can be disclosed by means of an osmosis test; concealed defects are present if both aqueous media having a high content of dissolved substances and aqueous media having a low content of dissolved substances exert no significant influence on the volume and the solidity, as substances are already directly exchanged via the defects. Staining offers a further possibility for the detection of non-intact citrus juice sacs. For this purpose, the citrus juice sacs are immersed into an aqueous dye solution made up of for example 0.1% carmine red (food product dye E120) and washed with water after standing for approximately 15 minutes at room temperature. Intact citrus juice sacs then appear almost undyed, whereas non-intact citrus juice sacs appear distinctly red owing to the infiltration of the dye into the interior of the citrus juice sac.

If a mixture according to the invention contains, in addition to intact (separated or non-separated) citrus juice sacs, also non-intact (separated or non-separated) citrus juice sacs, the numerical proportion of the intact citrus juice sacs based on the total amount of the citrus juice sacs should, as stated hereinbefore in a different context, be at least 50% or more, preferably 65% or more and particularly preferably 85% or more.

The steps distinguishing a method according to the invention for producing a mixture according to the invention were already mentioned hereinbefore. The steps are as follows:
a) preparing intact, separated citrus juice sacs, and
b) contacting the citrus juice sacs with one or more liquid aroma preparations, so that the aroma content of the citrus juice sacs is increased.

It was also already stated that, in a preferred production method according to the invention, the following further step is carried out:
c) freezing the citrus juice sacs obtained in accordance with step b) with aroma addition, in the presence or absence of the liquid aroma preparation or preparations.

Step a) of the method according to the invention (in particular in one of its preferred configurations) includes in this case preferably the separation of the citrus juice sacs starting from whole or peeled citrus fruits or citrus fruit segments. In particular, the methods or the apparatuses according to GB 978418, U.S. Pat. No. 3,246,993, U.S. Pat. No. 4,738,194 and JP 62000262 can be used. Separating methods or corresponding apparatuses in which the citrus juice sacs are separated with the aid of jets of liquid are also particularly suitable. Examples of these can be found in documents U.S. Pat. No. 4,294,861 and JP 57150373. In preferred configurations of step a) of a method according to the invention, citrus fruits are halved and a jet of liquid directed onto the cut surface, so that citrus juice sacs are flushed out and separated. According to an alternative configuration of step a), the fruits are peeled, divided into individual segments and these segments are treated with a jet of liquid. Again, citrus juice sacs are flushed out, which are then separated for example with the aid of a separating net from the remaining remnants of the fruit. As a further alternative, the method according to U.S. Pat. No. 4,560,572 can be used. In this case, the citrus fruits are peeled and separated into individual segments. If appropriate, extra-gastric digestion takes place. The segments are finally separated into individual juice sacs by compensating liquid flows. Compensating liquid flows are generated for example by opposing currents. The compensating currents between these opposing currents and the resulting forces lead to separation of the citrus juice sacs. For separating citrus juice sacs, peeled fruits can if appropriate also be shock-frosted in a cryogenic liquid at temperatures below −80° C. While the fruits are in this deep-frozen state, they are separated into the individual juice sacs by movement or by a mechanical influence (striking, impact, breaking, rolling). The citrus juice sacs are subsequently separated from the remaining constituents of the fruit, for example by sieving.

If step a) of the method according to the invention involves the application of a separating method in which the citrus fruit or the citrus juice sacs are treated with water, any remaining residual water should be separated off from the citrus juice sacs, which have now been separated, before carrying out step b). The water should be separated off as completely as possible, for example by allowing it to run off via sieves or the like and subsequently spreading the separated citrus juice sacs onto cloths (for example made of cotton or linen). Allowing the water to run off via appropriately mounted or clamped cloths is also possible, the prior use of sieves not being necessary. In individual cases, it is also sufficient to allow the water to run off only through sieves. If the water which is left behind after the separation process is completely removed, it cannot have an adverse effect in the following steps (for example a subsequent freezing step c)).

In a step b) according to the invention, the citrus juice sacs are contacted with one or more liquid aroma preparations, so that the aroma content of the citrus juice sacs is increased. As mentioned hereinbefore, this step b) is preferably carried out in such a way that one, a plurality of or all the aroma substances are taken up from the liquid aroma preparation or preparations into the citrus juice sacs, preferably into the encased juice of the citrus juice sacs.

In order to achieve the taking-up of one or more aroma substances into the encased juice of the citrus juice sacs, carrying out step b) of a method according to the invention preferably involves carrying out a mixing step in which the citrus juice sacs are mixed with one or more aroma preparations in such a way that the resulting mixture (comprising citrus juice sacs and one or more aroma preparations) comprises based on the total weight of the mixture 0.5-99.5% by weight of aroma preparation and 99.5-0.5% by weight of citrus juice sacs.

Preferably, the mixture produced in step b) (comprising citrus juice sacs and one or more aroma preparations) comprises based on the total weight of the mixture 2-70% by weight of aroma preparations and 98-30% by weight of citrus juice sacs, particularly preferably 5-60% by weight of aroma preparations and 95-40% by weight of citrus juice sacs.

When carrying out step b), care should be taken to ensure that preferably the entire surface of all citrus juice sacs to be treated is contacted with the liquid aroma preparation or preparations. The contacting provides in preferred configurations of the method according to the invention a coating, immersion and mixing in rotating equipment being particularly suitable as coating methods. During immersion, in order to achieve a complete coating (contacting of the entire citrus juice sac surface), the intact, separated citrus juice sacs are fully immersed into the corresponding aroma preparation. The immersion time will in this regard be between a few seconds and approximately 24 hours, depending on the requirements of the individual case, the immersion bath having in a large number of cases a temperature of from 0 to 60° C. After sufficient immersion time, the citrus juice sacs are removed from the immersion bath and conventionally substantially separated from the aroma preparation, for example by allowing the aroma preparation to run out through a sieve. The immersion bath used can be reused for coating further amounts of citrus juice sacs.

For mixing in rotating equipment, use can be made of dragée-making drums which allow the amount of aroma used to be significantly reduced compared to the immersion method. Mixtures consisting of 0.5-20% by weight of aroma preparation and 80-99.5% by weight of citrus juice sacs can conventionally be processed in dragée-making drums. The aroma preparation to be used can for example be sprayed onto or dripped onto the citrus juice sacs. The residence times in the dragée-making drums can be very short and last for example just 2-30 minutes, or else last up to a few hours.

It should also be noted that, in step b) of the method according to the invention, the aroma preparation is intended to wet at least the surface of the citrus juice sacs. However, more advantageous than mere wetting of the surface is if individual, a plurality of or all the aroma substances of the aroma preparation infiltrate the casing of the citrus juice sacs, and it is most particularly preferred if individual, a plurality of or all the aroma substances of the aroma preparation pass through the casing into the encased juice of the citrus juice sacs, so that finally a part of the aroma substances may be found in the casing and a further part in the juice.

In step b) of the method according to the invention, the intact, separated citrus juice sacs prepared in accordance with step a) should be used in a non-frozen state.

In preferred configurations of the method, after step b), the excess of the one or more aroma preparations is removed from the treated citrus juice sacs. Preferably, this excess is removed before carrying out step c) in preferred configurations of a method according to the invention.

It will be understood that step b) of a method according to the invention should if necessary be carried out repeatedly, for example in order to fill a citrus juice sac with various aroma substances which are present in different aroma preparations. Preferably, before carrying out the second step b), the remnants of liquid aroma preparation still clinging to the citrus juice sacs after carrying out the first contacting step b) are then removed before carrying out the second step b). The aroma preparations used in the second step b) are then preferably also removed (and preferably before carrying out step c)). The same applies to a third or each further carrying-out of step b).

Step c) of a preferred method according to the invention includes freezing the citrus juice sacs obtained in accordance with step b) with aroma addition in the presence or absence of the liquid aroma preparation or preparations. It is preferred insofar as the citrus juice sacs are cleansed before freezing of remnants of clinging liquid aroma preparations, i.e. if the excess of the one or more aroma preparations is removed before carrying out step c).

Although the freezing of the citrus juice sacs in step c) can generally take place at temperatures as low as −250° C., it is preferably carried out at a temperature in the range between the freezing temperature of the citrus juice sacs and a temperature above −73° C., preferably at a temperature in the range of from −15 to −40° C. The preferred configurations of a method according to the invention clearly differ from the prior art (cf. in particular U.S. Pat. No. 3,246,993 and GB 978418) in terms of the selection of the temperature range for freezing. Preferred methods according to the invention allow for the fact that the freezing process takes a very long time, so that only very few water crystals are formed. Whereas on the previous understanding it would have been assumed that these few water crystals would grow to form very large crystals and destroy the sac casings (cf. in this regard U.S. Pat. No. 3,246,993), independent investigations into the method according to the invention have surprisingly revealed no such phenomenon. Reference is therefore made to the following Examples 1 and 2. The freezing temperatures preferred within the scope of the present invention can be achieved using simple freezing technology (froster, freezer); corresponding systems are very economical both to purchase and to operate. Examples of suitable freezing apparatuses include plate frosters, cold air frosters, freezing cupboards, freezing tunnels, belt frosters, spiral belt frosters, freezing stores, freezing cells, freezing houses and freezers. The freezing can take place within a period of from a few minutes (approximately 2 minutes) to a few hours (approximately 48 hours), wherein the temperature of the citrus juice sacs should preferably be less than −15° C.

During freezing, the citrus juice sacs can be unpackaged; preferably, they are however in a packaging already during the freezing process. This prevents them from drying out, so that they are fully filled after thawing.

Preferably, step b) of a method according to the invention is carried out in such a way that the resulting citrus juice sacs with aroma addition are freeze and/or thaw-stabilized. Overall, a suitable method configuration results in increased stability in storage of the mixtures according to the invention. Deep-frozen citrus juice sacs according to the invention have a shelf life of from several months to a few years, in a large number of cases the shelf life being in the range between 6 months and 2 years. Citrus juice sacs with aroma addition are then freeze or thaw-stabilized if they remain intact during the freezing process or thawing process. Although the active mechanisms leading to freeze and/or thaw stabilization of the citrus juice sacs produced in the manner according to the invention have not yet been fully accounted for, the effect is believed to be based on the fact that the proportion of water in the casings of the citrus juice sac is reduced as a result of or simultaneously with the infiltration of aroma substances into the citrus juice sac, so that the harmful effects of the water are minimized. In particular, no crystallization of the (remaining) water would appear to take place in a freezing step c) in the sac casings or at the surface thereof, so that the sacs remain intact for this reason.

The invention will be described hereinafter in greater detail with reference to examples.

### EXAMPLE 1

### Mixture Comprising Valencia Late Juice Sacs with Aroma Addition

An orange (Valencia late) is peeled and divided into individual segments. The skin of each segment is opened carefully using a sharp knife. The segments are stretched outward, so that the citrus juice sacs loosen up. The pretreated segments are placed in a 2-litre beaker glass and treated with a jet of water. For this purpose, a flexible plastics material hose having an internal diameter of 7 mm is connected to a water line and the operator restricts the hose opening by pressing it with his fingers. The jet is directed at the edge into the beaker glass, so that the pretreated orange segments perform almost a circular movement. The beaker glass is increasingly filled and starts to overflow. The separated citrus juice sacs entrained in the overflowed water are collected with the aid of a sieve. The water is allowed to run through the sieve. The juice sacs obtained are predominantly (>95%) intact and predominantly (>99%) separated.

15 g of the citrus juice sacs are placed in 15 g of orange peel oil (aroma preparation) and placed in a deep-freezer at −18° C. for 24 hours. Once removed, the deep-frozen juice sacs are sieved out of the orange peel oil and subsequently thawed at room temperature.

The thawed citrus juice sacs are still intact (>95%) and bulging with juice. There is no sign of any juice having seeped out. During tasting, the texture corresponds substantially to the texture of the non-frozen citrus juice sacs. When the taster applies a slight pressure on the citrus juice sacs with his tongue, the juice sprays into his oral cavity. The citrus juice sacs taste in this case pleasantly aromatized. The analysis of the aroma content yielded a value of 4,086 ppm.

### EXAMPLE 2

### Comparative Example

Example 1 is repeated, wherein the citrus juice sacs are not placed in the orange peel oil prior to freezing. After thawing, analysis under a microscope reveals at least 90% of the citrus juice sacs to be defective, i.e. no longer intact, and a large part of the juice has seeped out. The few citrus juice sacs which still appear to be intact when analyzed under a microscope are not bulging with juice and appear rather flaccid, i.e. are presumably also not intact. During tasting, the typical texture of the intact citrus juice sacs is missing. The analysis of the aroma content revealed a value of just 15 ppm.

The comparison of Example 1 and Example 2 points up above all the positive effect of the aroma addition on the texture and the integrity of the citrus juice sacs. The aromatizing of the citrus juice sacs does not lead to an increase in the aroma content; instead, the resistance of the citrus juice sacs to the freezing and thawing process rises additionally and unexpectedly. According to the prior art to date, it is possible to achieve intact, separated citrus juice sacs only during freezing below −73° C. In Example 1, on the other hand, freeze and thaw-stable juice sacs were successfully produced at just −18° C.

### EXAMPLE 3

### Mixture Comprising Grapefruit Juice Sacs with Aroma Addition

The citrus juice sacs of a grapefruit are separated using the procedure described in Example 1. 100 g of the separated citrus juice sacs are immersed into 100 g of grapefruit essence oil (as the aroma preparation) and left for 24 hours at room temperature. The grapefruit essence oil is separated off using a sieve and the citrus juice sacs are frozen at −18° C. After thawing, the grapefruit juice sacs remain intact. The texture corresponds during tasting approximately to the texture of the untreated and intact citrus juice sacs, a pleasantly strong aroma impression being perceived.

### EXAMPLE 4

### Mixture Comprising Grapefruit Juice Sacs with Aroma Addition

The citrus juice sacs of a grapefruit are separated using the procedure described in Example 1. 100 g of the separated citrus juice sacs are mixed for 15 minutes in a dragée-making drum at 15 rpm with 10 g of grapefruit essence oil and subsequently deep-frozen at −18° C.

### EXAMPLE 5

### Mixture Comprising Grapefruit Juice Sacs with Aroma Addition

A grapefruit is cut into 2 halves using a knife and treated with the jet of water from Example 1. The separated citrus juice sacs are coated in a dragée-making drum with 5 g of an aroma preparation, in this case natural vanilla extract, and frozen at −18° C.

### EXAMPLE 6

### Rice Meal Comprising Aromatized Grapefruit Juice Sacs

Example 5 is repeated, a coriander aroma preparation being used instead of the vanilla extract. 2 g of the deep-frozen citrus juice sacs, aromatized with coriander aroma, are added to a rice ready meal (100 g).

### EXAMPLE 7

### Sorbet comprising Aromatized Grapefruit Juice Sacs

A sorbet mass is made up of 19% sugar, 5% glucose sirup, 0.4% whipping agent, 0.5% citric acid and 75.1% water and cooled down to 4° C. 10 g of the citrus juice sacs from Example 4 are added to 90 g of this mass and carefully folded in. The mass is frozen at −18° C.

When the sorbet is eaten, the citrus juice sacs according to the invention produce a pleasant texture. When the taster bites into or crushes the citrus juice sacs between his tongue and palate, he perceives a strong aroma impression.

### EXAMPLE 8

### Rice Noodle Dish Comprising Citrus Juice Sacs with Beef Aroma

Deep-frozen, intact, separated citrus juice sacs with a beef aroma additive (1% by weight) are added to a meal comprising rice noodles (Kritharaki).

### EXAMPLE 9

### Yoghurt Comprising Aromatized Grapefruit Juice Sacs

The citrus juice sacs, aromatized with vanilla, from Example 5 are added to a yoghurt which is stirred until it is creamy (5 g/100 g yoghurt).

### EXAMPLE 10

### Analysis Example

Orange citrus juice sacs are separated as in Example 1. The intact, separated citrus juice sacs are immersed into the same amount of d-cedrates (as the aroma preparation) and left at room temperature. After specific intervals, samples (a number of citrus juice sacs) are taken, washed with cold water on a sieve and their cedrate content is subsequently determined. The results are set out in the following table.

| | |
|---|---|
| Time | Cedrate content |

| | | |
|---|---|---|
| 1 | hour | 0.9% |
| 3 | hours | 1.8% |
| 7 | hours | 2.1% |
| 24 | hours | 2.6% |

The results show the timing of the take-up of aroma substance into the citrus juice sacs. After just 3 hours, the citrus juice sacs are to a large extent enriched with d-cedrates; an extended standing time leads only to a very slow take-up of aroma substance.

It is claimed:

1. A mixture comprising or consisting of intact, separated citrus juice sacs with aroma addition, wherein these citrus juice sacs have an aroma content of 50 ppm (0.005% by weight) or more, based on their total weight.

2. The mixture as claimed in claim 1, wherein the intact, separated citrus juice sacs with aroma addition have an aroma content of 500 ppm (0.05% by weight) or more, based on their total weight.

3. The mixture as claimed in claim 1, wherein the proportion formed by the aroma addition of the aroma total weight of said citrus juice sacs is 50% by weight or more.

4. The mixture as claimed in claim 1, wherein the citrus juice sacs are frozen with aroma addition contained therein.

5. The mixture as claimed in claim 1, further comprising a number of non-intact and/or non-separated citrus juice sacs,
wherein the numerical proportion of the separated, intact or non-intact citrus juice sacs is 50% or more, based on the total amount of the citrus juice sacs, and/or
the numerical proportion of the intact, separated or non-separated citrus juice sacs is 50% or more, based on the total amount of the citrus juice sacs.

6. The mixture as claimed in claim 1, wherein the mixture is a preparation for (a) nutrition, or (b) consumption for pleasure or (c) a corresponding semifinished product.

7. A method for aromatizing (a) preparations or semifinished products used for nutrition, or consumption for pleasure or (b) a corresponding semifinished product or (c) a preparation used for nutrition, or consumption for pleasure comprising adding intact, separated citrus juice sacs with aroma addition to the preparations or semifinished products, wherein these citrus juice sacs have an aroma content of 50 ppm (0.005% by weight) or more, based on their total weight.

8. A method for producing a mixture comprising or consisting of intact, separated citrus juice sacs with aroma addition, wherein these citrus juice sacs have an aroma content of 50 ppm (0.005% by weight) or more, based on their total weight, including the following steps:
a) preparing intact, separated citrus juice sacs, and
b) contacting the citrus juice sacs with one or more liquid aroma preparations, so that the aroma content of the citrus juice sacs is increased.

9. The method as claimed in claim 8, including the following further step:
c) freezing the citrus juice sacs obtained in accordance with step b) with aroma addition, in the presence or absence of the liquid aroma preparation or preparations.

10. The method as claimed in claim 9, wherein the freezing of the citrus juice sacs in step c) takes place at a temperature in the range between their freezing temperature and a temperature above −73° C.

11. The method as claimed in claim 8, wherein step b) is carried out in such a way that one, a plurality of or all the aroma substances are taken up from the liquid aroma preparation or preparations into the citrus juice sacs.

12. The method as claimed in claim 8, wherein after step b) the excess of the one or more aroma preparations is removed.

13. The method as claimed in claim 8, wherein step a) includes the separation of the citrus juice sacs starting from whole or peeled citrus fruits or citrus fruit segments.

14. The method as claimed in claim 8, wherein the contacting of the prepared citrus juice sacs in step b) takes place by mixing the citrus juice sacs with one or more aroma preparations, the resulting mixture, comprising citrus juice sacs and one or more aroma preparations, comprising 0.5 to 99.5% by weight of aroma preparations and 99.5 to 0.5% by weight of citrus juice sacs, based on the total weight of the mixture.

15. The method as claimed in claim 14, wherein the mixture produced in step b), comprising citrus juice sacs and one or more aroma preparations, comprises 2 to 70% by weight, of aroma preparations and 98 to 30% by weight of citrus juice sacs, based on the total weight of the mixture.

16. The method as claimed in claim 8, wherein the aroma content of the encased juice of the citrus juice sacs prepared in step a) as a result of the aroma addition taking place in accordance with step b)
is increased by 20 ppm or more and/or
is increased by 10% by weight or more,
based on the aroma content before the aroma addition.

17. The method as claimed in claim 8, wherein step b) is carried out in such a way that the resulting citrus juice sacs with aroma addition are freeze and/or thaw-stabilized.

18. The method as claimed in claim 8, wherein the citrus juice sacs present in step a) and b) are not frozen.

19. A method for increasing the aroma content of the encased juice of a citrus juice sac comprising addition of the mixture of claim 1.

20. The mixture as claimed in claim 1, wherein the intact, separated citrus juice sacs with aroma addition have an aroma content of 1000 ppm (0.1% by weight) or more, based on their total weight.

21. The mixture as claimed in claim 5, wherein the numerical proportion of the separated, intact or non-intact citrus juice sacs is 90% or more, based on the total amount of the citrus juice sacs.

22. The mixture as claimed in claim 5, wherein the numerical proportion of the intact, separated or non-separated citrus juice sacs is 65% or more, based on the total amount of the citrus juice sacs.

23. The method as claimed in claim 12, wherein before step c) the excess of the one or more aroma preparations is removed.
